(19) United States
(12) Patent Application Publication
(10) Pub. No.: US 2021/0231308 A1
(43) Pub. Date: Jul. 29, 2021

(54) FLAME SIMULATING DEVICE AND ELECTRIC FIREPLACE

(71) Applicant: JIANGMEN KEYE ELECTRIC APPLIANCES MANUFACTURING CO., LTD, Jiangmen City (CN)

(72) Inventors: Xiangming He, Jiangmen City (CN); Guanglian Lin, Jiangmen City (CN)

(21) Appl. No.: 17/021,213

(22) Filed: Sep. 15, 2020

(30) Foreign Application Priority Data
Jan. 23, 2020 (CN) 202010076473.5

(51) Int. Cl. F24C 7/00; F21S 10/04; F21V 5/04

(52) U.S. Cl. CPC F24C 7/004; F21V 5/048; F21S 10/046

(57) ABSTRACT

Provided is a flame simulating device including a light source, a rotary light-transmitter, an imaging plate and a swing unit; the light source emits a first light group; the first light group is projected to the light-transmitter to form a second light group; the light source is disposed on the swing unit, and the swing unit drives the light source to move relatively around the light-transmitter.

### CROSS-REFERENCE TO RELATED APPLICATIONS

This application claims priority to Chinese Application No. CN202010076473.5, having a filing date of Jan. 23, 2020, the entire contents of which are hereby incorporated by reference.

### FIELD OF TECHNOLOGY

The following relates to the field of electric fireplaces, in particular to a flame simulating device which can simulate flickering flames and an electric fireplace installed with the flame simulating device.

### BACKGROUND

As decorative equipments which integrate modern optical principles, electric fireplaces have many outstanding decorative effects and are widely used. With electric energy as energy source, electric fireplaces provide no real flame but two-dimensional or three-dimensional simulated flames which are generated by reflection of lights, coupled with artificial charcoal to produce a visual effect of simulating flame combustion.

### SUMMARY

An aspect relates to flame simulating device and an electric fireplace installed with any one of the above flame simulating devices.

In some embodiments, a flame simulating device includes a light source, a rotary light-transmitter, an imaging plate and a swing unit; the light source emits a first light group; the first light group is projected to the light-transmitter to form a second light group; the light source is disposed on the swing unit, and the swing unit drives the light source to move relatively around the light-transmitter.

In some embodiments, the swing unit includes a swing shelf, which includes a base shelf and a connecting bridge; one end of the connecting bridge is fixed to the base shelf, and the other end is connected to the light-transmitter; the light source is disposed on the base shelf which can swing around the end where the connecting bridge is mounted to the light-transmitter.

In some embodiments, the swing unit includes a knob and a driving component which is coupled with the knob, and the driving component is also coupled with the connecting bridge.

In some embodiments, one end of the connecting bridge is fixed to the base shelf, and the other end of the connecting bridge is sleeved on the rotary axle of the light-transmitter.

In some embodiments, the base shelf is a strip plate which is parallel to the rotary axle of the light-transmitter.

In some embodiments, the swing unit includes a driving component; the driving component includes a driving shaft, and one end of the driving shaft is fixed to the connecting bridge to drive the connecting bridge to rotate.

In some embodiments, the driving component includes a worm gear and a worm; the worm gear is sleeved and fixed on the driving shaft, and the worm meshes with the worm gear.

In some embodiments, the light-transmitter is provided with a plurality of light-mixing blocks, and the first light group is projected into the light-transmitter and the light-mixing blocks thereof to form a second light group.

In some embodiments, the light-mixing block is a convex lens or a concave lens, or a combination of both.

In some embodiments, the light-transmitter includes at least two sub light-transmitters connected through a connecting component, each sub light-transmitter is a rotary body formed by rotating an arch arc around a axial, the light-mixing blocks are arranged along a circumferential direction of the light-transmitter to form a light-mixing block circle, and a number of light-mixing block circles are arranged along an axial direction of the light-transmitter.

In some embodiments, an electric fireplace includes a cabinet, a window provided in the front side of the cabinet which connects the inner cavity of the cabinet, and the flame simulating device is provided in the inner cavity of the cabinet.

In some embodiments, the electric fireplace includes a knob and a driving component which is coupled with the knob; the driving component includes a driving shaft, a worm gear and a worm, the worm gear is sleeved and fixed on the driving shaft, and the worm meshes with the worm gear; the knob is sleeved on the end of the worm and is disposed on the cabinet.

### BRIEF DESCRIPTION

Some of the embodiments will be described in detail, with reference to the following figures, wherein like designations denote like members, wherein:

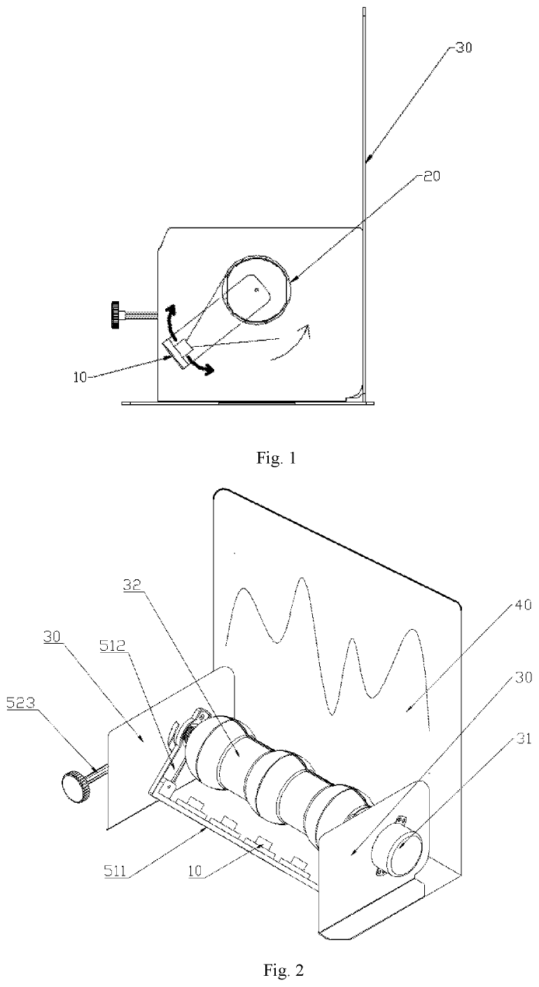

FIG. 1 is a simplified view of the structure of the flame simulating device in some embodiments;

FIG. 2 is an overall view of the structure of the flame simulating device in some embodiments;

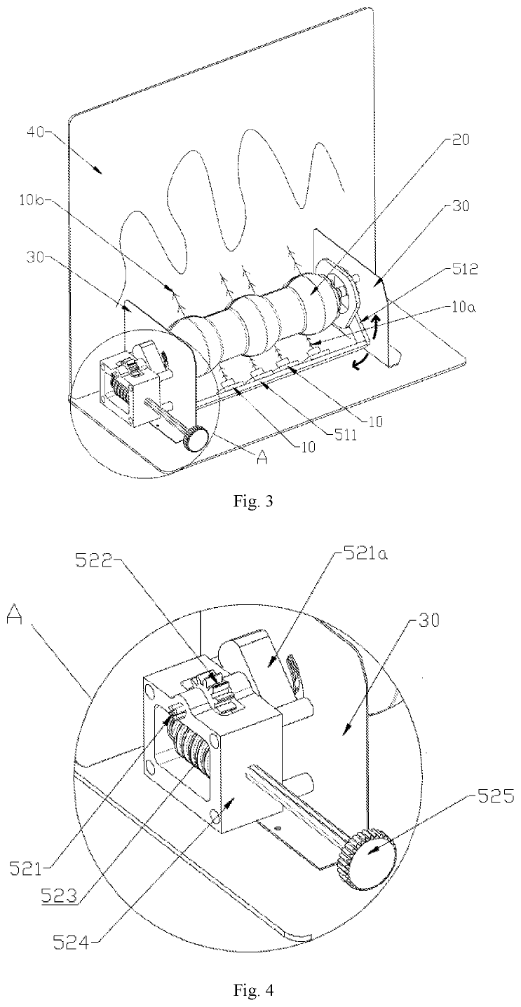

FIG. 3 is a side view of the structure of the flame simulating device in some embodiments;

FIG. 4 is an enlarged view A of FIG. 3;

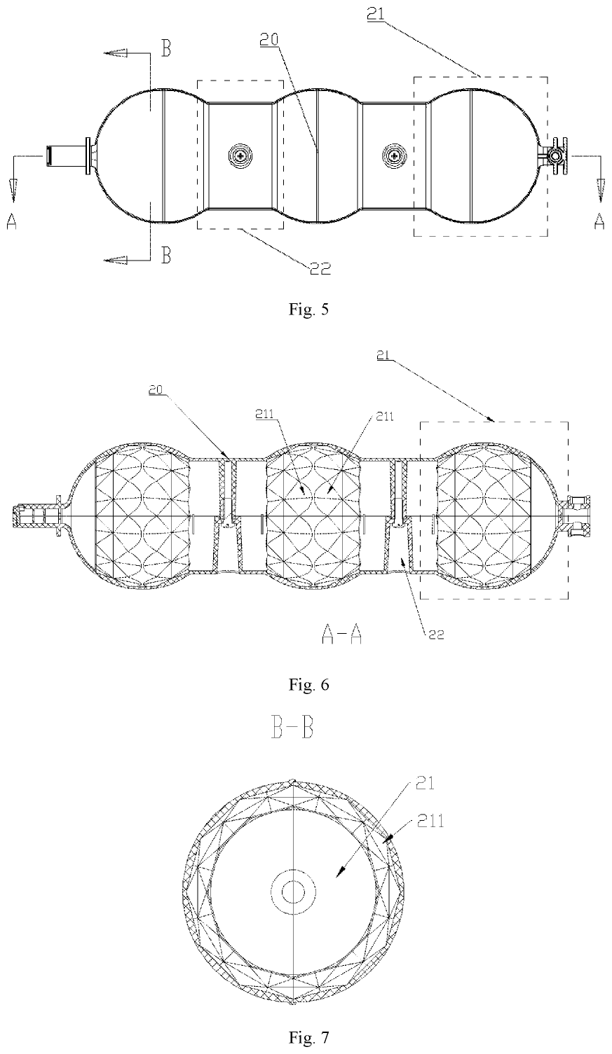

FIG. 5 is a structural diagram of the light-transmitter in some embodiments;

FIG. 6 is an A-A sectional view of the light-transmitter in some embodiments;

FIG. 7 is a B-B sectional view of the light-transmitter in some embodiments; and

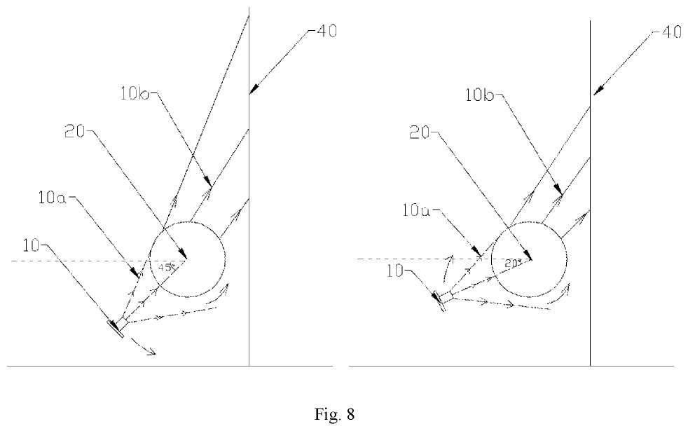

FIG. 8 is a schematic diagram of the flame height adjustment in some embodiments.

Reference numerals in the figures: 10—light source, 10a—first light group, 10b—second light group, 20—light-transmitter, 21—sub light-transmitter, 22—connecting component, 211—light-mixing block, 30—support frame, 31—motor, 40—imaging plate, 511—base shelf, 512—connecting bridge, 521—driving shaft, 521a—connecting block, 522—worm gear, 523—worm, 524—positioning shell, 525—knob.

### DETAIL DESCRIPTION

For a better understanding and implementation, embodiments of the present invention will be described in detail below in combination with accompanying drawings.

Please refer to FIGS. 1-4, in some embodiments, an electric fireplace includes a cabinet, a simulated fuel (not shown) and a flame simulating device provided in the cabinet, wherein the front side face of the cabinet is provided with a window, which connects the inner cavity of the cabinet, and the flame simulating device is disposed in the inner cavity of the cabinet.

The simulated fuel is disposed near the window, and the simulated fuel can be seen when looking from the window to the inner cavity of the cabinet. In some embodiments, the simulated fuel includes simulated embers and simulated charcoal, a plurality of simulated charcoal stacked on the simulated embers pile, and the plurality simulated charcoal inclined toward the inner cavity. The simulated charcoal is made of light-transmitting resin and is grayish black. In some embodiments, a simulated fuel light source (not shown) for illuminating the simulated fuel is disposed below the simulated fuel. In some embodiments, the simulated fuel light source is an LED lamp, and the LED lamp is orange-red or orange-yellow.

The flame simulating device includes a light source 10, a light-transmitter 20, an imaging plate 40 and a swing unit. The light source 10 emits a first light group 10a; the first light group 10a is projected to the light-transmitter 20 to form a second light group 10b, and the second light group 10b is projected on the imaging plate 40 to form an image. The light source 10 is disposed on the swing unit, the swing unit drives the light source 10 to move relatively around the light-transmitter, the swing unit changes the angle that the first light group emitted to the light-transmitter, thus to make the image projected on the image plate formed by the second light group move, increase or decrease.

In some embodiments, the light source 10 is an LED light source 10, which includes at least one row of LED arrays arranged at equal intervals by a number of LED luminous chips. The LED arrays are arranged parallel to the axial direction of the light-transmitter and are directly opposite to the light-transmitter. Each of the LED arrays includes at least a blue LED light and an orange-red LED light.

In some embodiments, the light-transmitter 20 is a symmetrical or asymmetric structure, and in some embodiments, the light-transmitter 20 is a solid or hollow structure. In some embodiments, the light-transmitter 20 is a sphere, a cylinder, or a rotary body formed by rotating an arched arc as a generatrix around a line formed by the two ends of the arc or a line parallel to this line as an axis In some embodiments, the light-transmitter 20 is provided with a number of light-mixing blocks 211 which are convex lenses or concave lenses, or a combination of both. When the sub light-transmitter 21 is hollow, the light-mixing blocks 211 are disposed on its outer wall and/or an inner wall. When the light-transmitter 21 is solid, the light-mixing blocks 211 are disposed on its outer surface. The light emitted by the light source 10 creates a mixing effect of reflection, refraction, concentration, and astigmatism between these convex lenses, concave lenses, or a combination thereof.

In some embodiments, the light-transmitter 20 includes at least three sub light-transmitters 21. These sub light-transmitters 21 are coaxially arranged and connected through a connecting component 22. Referring to FIGS. 5-7, the sub light-transmitter 21 is a hollow sphere, or a rotary body formed by rotating an arched arc as a generatrix around a line formed by the two ends of the arc or a line parallel to this line as an axis. The light-mixing blocks 211 are disposed on the inner surface of the sub light-transmitter. The light-mixing blocks 211 are closely arranged along a circumferential direction of the sub light-transmitter 21 to form a light-mixing block circle, and a number of light-mixing block circles are arranged along an axial direction of the sub light-transmitter 21. In some embodiments, the connecting component 22 may be transparent or opaque. In some embodiments, the connecting component 22 is a cylinder with a diameter slightly smaller than the said hollow sphere, and the surface of the connecting component 22 is provided with a frosted surface to form an opaque structure, and reduce the mutual interference between the light passing through each sub light-transmitter 21.

The light-transmitter 20 is arranged on the bottom plate (not shown) of the cabinet through a support frame 30. In some embodiments, the rotary axle shaft of the light-transmitter 20 is hinged and threaded on the support frame 30, and the light-transmitter 20 is driven to rotate by a motor 31. The light-mixing blocks make light reflect, refract, condense, and diverge between the convex lenses, the concave lenses, or a combination of the two, thus forming the light mixing effect.

In some embodiments, the imaging plate 40 is a rear shell plate of the cabinet, and a wallpaper with a brick pattern is pasted thereon. In some embodiments, the imaging plate 40 is a transparent plate disposed in the middle of the cabinet, in some embodiments, the imaging plate 40 is a translucent plate made from hard transparent plastic with excellent optical properties.

The swing unit includes a swing shelf and a driving component. The driving component drives the swing shelf to move around the light-transmitter. In some embodiments, the driving component drives the swing shelf to swing about the rotary axle of the light-transmitter. In some embodiments, the swing shelf includes a base shelf 511 and a connecting bridge 512; one end of the connecting bridge 512 is fixed to the base shelf 511, and the other end is connected to the light-transmitter. In some embodiments, the base shelf 511 is a strip plate which is parallel to the rotary axle of the light-transmitter; the light sources 10 are arranged on the base frame 511 and arranged at equal intervals in the length direction of the strip plate. In some embodiments, the length of the base shelf 511 is similar to or equal to the length of the light-transmitter. In some embodiments, there are two connecting bridges 512 provided at two ends of the base shelf 511, one end of each connecting bridge 512 is fixed to the base shelf 511, and the other end is sleeved on the rotary shaft of the light-transmitter 20 and is hinged on the support frame 30, so that the swing shelf can drive the light source 10 to swing around the rotary axle of the light-transmitter 20.

Referring to FIG. 4, the driving component includes a driving shaft 521, a worm gear 522 and a worm 523 that meshes with the worm gear 522. One end of the driving shaft 521 is fixed to the connecting bridge 512 through a connecting block 521a, and the driving shaft 521 drives the connecting bridge 512 to rotate. The worm gear 522 is sleeved and fixed on the driving shaft 521, the worm gear 522 is a gear-like structure provided with teeth, the middle and front part of the worm 523 is provided with spiral teeth, and the spiral teeth of the worm 523 mesh with the teeth of the worm gear 522. In some embodiments, the driving component is disposed in a positioning shell 524, which is a hollow shell with an opening at the top thereof. The driving shaft 521 penetrates the positioning shell 524 and is connected to the connecting block 521a. In the cavity of the positioning shell 524, the worm gear 522 is sleeved on the driving shaft 521 and exposed from the opening, and the spiral teeth at one end of the worm 523 are engaged with the teeth of worm gear. The other end of the worm 523 is exposed outside the positioning shell 524. When the worm 523 is turned counterclockwise or clockwise, different positions on the spiral teeth mesh with the worm gear 522, thereby driving the worm gear 522 and the driving shaft 521 to rotate forward or reverse in the opening, and the driving shaft 521 drives the connecting bridge 512 to rotate, thus drives the base shelf 511 and the light source 10 disposed thereon to rotate reciprocally around the light-transmitter.

In some embodiments, the swing unit also includes a knob 525, which is sleeved on the end of the worm 523 exposed outside the positioning shell 524, and is also disposed on the cabinet. In some embodiments, the knob 525 is disposed on a front side of the cabinet. When the knob 525 is rotated, the worm 523 fixed to the knob also rotates accordingly, thus driving the worm gear 522 and the driving shaft 521 to rotate, thereby adjusting the incident angle of the light source 10 and the light-transmitter 20, and adjusting the flame size or height on the imaging plate 40. In addition, the knob 525 is set on the front side of the fireplace cabinet to facilitate a user's operation.

Next the theory of height adjustment of the simulated flame on the imaging plate 40 will be described. During the movement of the light source 10 around the light-transmitter 20, the incident angle of the first light group 10a emitted by the light source 10 into the light-transmitter will change. Therefore, the exit angle of the group of light 10b also changes, and then images are formed in different height ranges on the imaging plate 40, and flames of different sizes are simulated. In some embodiments, in order to facilitate the explanation of the theory, the incident angle is defined herein as the included angle between the line, which connects the light source 10 and the center of the light-transmitter, and the horizontal plane, and the incident angle of the light source 10 is assumed to vary between 45° and 20°. Please refer to FIG. 8, in the initial state, when the incident angle of the light source 10 is 45°, the incident angle of the first light group 10a entering the light-transmitter is the largest, and at this time, the “flame area” formed by the second light group 10b irradiating on the imaging plate 40 is the largest, with the overall effect that the height of the flame presented on the imaging plate 40 is the highest, covering almost the entire imaging plate 40; when the incident angle of the light source 10 decreases gradually, the “flame area” formed by the second light group 10b on the imaging plate 40 gradually becomes smaller, with the overall effect that the height of the flame presented on the imaging plate 40 gradually decreases; when the incident angle of the light source 10 is 20°, the incident angle of the first light group 10a entering the light-transmitter is the smallest, and the “flame area” formed by the formed second light group 10b on the imaging plate 40 is the smallest, with the overall effect that the height of the flame presented on the imaging plate 40 is the shortest. The above incident angle is defined as 45°-20° only as a theoretical explanation. In some embodiments, the incident angle can be adjusted according to the distance between the light source 10 and the light-transmitter 20, the height of the imaging plate 40 and other factors, so as to obtain the best effect for simulating a flame.

When in use, the first light group emitted by the light source after powered on projected into the rotary light-transmitter, it passes through the light-transmitter and the light-mixing blocks disposed on the light-transmitter to generate multiple times of reflection, refraction, concentration and astigmatism, and then a second light group is formed and projected onto the imaging plate to achieve light spots of different brightness and darkness. As the surface of the light-transmitter with an arc structure, and the position of each light-mixing block on the light-transmitter is different, and the distance from each light-mixing block to the imaging plate is also different, so after light passes through different light-mixing blocks, the size, shape, brightness, and position of the light spots formed on the imaging plate are different, and with the rotating of the light-transmitter, the mixed light on the imaging plate shows the effects of the flickering flames and the jumping flames. Meanwhile, by rotating the knob, the swing unit driving the light source to move around the light-transmitter, the incident angle of the first light group emitted by the light source and the light-transmitter is adjusted, and the angle of the second light group formed by the first light group after transmitting through the light-transmitter is also changed; the range of the images formed by the second light group projected on the imaging plate is different with an overall result of different flame heights on the imaging plate, thus the effect of adjusting the size of simulated flame is achieved.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality.

What is claimed:

1. A flame simulating device, wherein the flame simulating device comprises a light source, a rotary light-transmitter, an imaging plate and a swing unit; the light source emits a first light group; the first light group is projected to the light-transmitter to form a second light group; the light source is disposed on the swing unit, and the swing unit drives the light source to move around the light-transmitter.

2. The flame simulating device of claim 1, wherein the swing unit comprises a swing shelf, the swing shelf comprises a base shelf and a connecting bridge; one end of the connecting bridge is fixed to the base shelf, and an other end is connected to the light-transmitter; the light source is disposed on the base shelf which can swing around the end where the connecting bridge is mounted to the light-transmitter.

3. The flame simulating device of claim 2, wherein the swing unit further comprises a flame adjusting knob and a driving element which is coupled with the flame adjusting knob, and the driving element is also coupled with the connecting bridge.

4. The flame simulating device of claim 3, wherein one end of the connecting bridge is fixed to the base shelf, and the other end of the connecting bridge is sleeved on the rotary axle of the light-transmitter.

5. The flame simulating device of claim 4, wherein the base shelf is a strip plate which is parallel to the rotary axle of the light-transmitter.

6. The flame simulating device of claim 4, wherein the swing unit comprises a driving component; the driving component comprises a driving shaft, and one end of the driving shaft is fixed to the connecting bridge to drive the connecting bridge to rotate.

7. The flame simulating device of claim 6, wherein the driving component comprises a worm gear and a worm; the worm gear is sleeved and fixed on the driving shaft, and the worm meshes with the worm gear.

8. The flame simulating device of claim 7, wherein the light-transmitter is provided with a plurality of light-mixing blocks, and the first light group is projected into the light-transmitter and the light-mixing blocks thereof to form a second light group.

9. The flame simulating device of claim 8, wherein the light-mixing blocks are selected from a group consisting of convex lenses, concave lenses and a combination of convex lenses and concave lenses.

10. The flame simulating device of claim 9, wherein the light-transmitter comprises at least two sub light-transmitters connected through a connecting component, each sub light-transmitter is a rotary body formed by rotating an arch arc around a axial, the light-mixing blocks are arranged along a circumferential direction of the light-transmitter to form a light-mixing block circle, and a number of light-mixing block circles are arranged along an axial direction of the light-transmitter.

11. An electric fireplace, comprising a cabinet and a window provided in the front side of the cabinet, the window connects the inner cavity of the cabinet, wherein a flame simulating device of claim 1 is provided in the inner cavity of the cabinet.

12. The electric fireplace of claim 11, wherein the swing unit comprises a swing shelf, which comprises a base shelf and a connecting bridge; one end of the connecting bridge is fixed to the base shelf, and the other end is connected to the light-transmitter; the light source is disposed on the base shelf which can swing around the end where the connecting bridge is mounted to the light-transmitter.

13. The electric fireplace of claim 12, wherein the swing unit comprises a knob and a driving component which is coupled with the knob, and the driving component is also coupled with the connecting bridge.

14. The electric fireplace of claim 13, wherein one end of the connecting bridge is fixed to the base shelf, the other end of the connecting bridge is sleeved on the rotary axle of the light-transmitter; the base shelf is a strip plate which is parallel to the rotary axle of the light-transmitter.

15. The electric fireplace of claim 13, wherein the swing unit comprises a driving component; the driving component comprises a driving shaft, and one end of the driving shaft is fixed to the connecting bridge to drive the connecting bridge to rotate.

16. The electric fireplace of claim 15, wherein the driving component further comprises a worm gear and a worm; the worm gear is sleeved and fixed on the driving shaft, and the worm meshes with the worm gear.

17. The electric fireplace of claim 16, wherein the light-transmitter is provided with a plurality of light-mixing blocks, and the first light group is projected into the light-transmitter and the light-mixing blocks thereof to form a second light group.

18. The electric fireplace of claim 17, wherein the light-mixing blocks are selected from a group consisting of convex lenses, concave lenses and a combination of convex lenses and concave lenses.

19. The electric fireplace of claim 18, wherein the light-transmitter comprises at least two sub light-transmitters connected through a connecting component, each sub light-transmitter is a rotary body formed by rotating an arch arc around a axial, the light-mixing blocks are arranged along a circumferential direction of the light-transmitter to form a light-mixing block circle, and a number of light-mixing block circles are arranged along an axial direction of the light-transmitter.

20. The electric fireplace of claim 19, wherein the knob is sleeved on the end of the worm and is disposed on the cabinet.
